(19) United States
(12) Patent Application Publication
(10) Pub. No.: US 2004/0190868 A1
(43) Pub. Date: Sep. 30, 2004

(54) Recording apparatus and content protection system

(76) Inventors: Toshihisa Nakano, Neyagawa-shi (JP); Yuichi Futa, Osaka-shi (JP); Motoji Ohmori, Hirakata-shi (JP); Shunji Harada, Osaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/802,927

(22) Filed: Mar. 18, 2004

(30) Foreign Application Priority Data
Mar. 24, 2003 (JP) 2003-081467

(51) Int. Cl. H04N 5/76; H04N 7/167

(52) U.S. Cl. 386/94; 380/201

(57) ABSTRACT

A recording apparatus (100) comprises a receiving unit (301) operable to receive content, a control unit (302) operable to determine a recording method of the content on a recording media (120), and a R/W unit (305) operable to write in and read out on the recording media. The control unit (302) includes a recording media identification unit (302a) operable to identify a type of the recording media via the R/W unit (305), a source identification unit (302b) operable to judge a type of a source about whether or not the received content is a content subject to a content protection, a recording method selection unit (302c) operable to select a recording method of the content on the recording media (120), and a recording method conversion unit (302d).

### TECHNICAL FIELD

The present invention relates to a recording apparatus and a content protection system (CPS) used for recording digital data of contents, which are copyrighted works such as movie and music, on recording media such as an optical disk and especially relates to a recording apparatus and a content protection system which are capable of corresponding to a plurality of content protection recording methods.

### BACKGROUND ART

In recent years, following a development of multimedia related technologies, an emergence of mass storage media, and the like, a system which distributes digital content composed of data such as video and audio (hereafter referred to as content), the content being generated and stored in a mass storage medium such as an optical disk, or distributes the content via a network is appeared. The distributed content is to be recorded with a recording apparatus on recording media such as DVD, and to be played back after the content is read out by a computer, a playback apparatus and the like.

In general, an encryption technology is used to protect a copyright of content, that is, to prevent an unauthorized playback and an unauthorized use of the content such as an unauthorized copying. The methods of encrypting the content and recording it on a recording medium include a recording method which encrypts the content itself with an encryption key corresponding to a decryption key held by a terminal, and a recording method which encrypts a key for a decryption corresponding to the key which encrypts the content, using an encryption key corresponding to the decryption key held by the terminal.

In this case, while the decryption key which the terminal holds needs to be controlled strictly for not being discovered by outsiders, it is a possible danger that a key to be disclosed externally by an analysis of an inside of the terminal by an unauthorized person. Once a key is disclosed by the unauthorized person, a recording apparatus, a playback apparatus, and software which use content without authorizations are generated and distributed over the Internet and the like. In such case, a copyright holder wishes that the once disclosed key were not be able to be used for a next provided content. A technology for realizing this is called a key revocation technology (for example, refer to Japanese Laid-Open Patent application No. 2002-281013).

FIG. 12 is an explanatory diagram to explain the key revocation technology. A content protection system using this key revocation technology writes a Media ID (MID) 1203 and Key Revocation Data (KRD) 1202 in a non-rewritable area 1201a of a recording medium 1201.

In FIG. 12, the recording medium 1201 such as an optical disk has the non-rewritable area 1201a and a rewritable area 1201b. The non-rewritable area 1201a is a reading only area in which the key revocation data (KRD) 1202 and the media ID (MID) 1203 are recorded. Also, an encrypted content key 1204 and an encrypted content 1205 are recorded in the rewritable area 1201b.

In a usual condition, a device 1 such as a playback apparatus (1206), to use an encrypted content recorded on the recording medium 1201, obtains a media key (MK) by decrypting an encrypted sentence (E) with a device key 1 (Devkey 1), then obtains a content key (CK) by decrypting the encryption of the encrypted content key 1204, and plays back content by decrypting an encrypted content 1205 with the content key (CK).

Then, for example, when the device key 2 (Devkey 2) corresponding to a device 2 is disclosed by an unauthorized person, an official media key (MK) cannot be obtained even if the encryption sentence (E) in the key revocation data 1202 is encrypted, and only revoked data (xxx) is obtained. The apparatus 2 thereof cannot encrypt an official content key (CK) and unauthorized use of content is prevented.

Thus, in a key revocation technology as a content protection system, an unauthorized use of content is prevented by revoking a key for a decryption (a device key 2 in FIG. 12) using the key revocation data 1202.

While it is general that content recorded on a recording medium such as an optical disk are read out and written with peripheral apparatuses of a personal computer called an optical disk drive, methods of its input and output are standardized as public information in order to achieve a compatibility of the apparatuses. Therefore, it is easy to read out the content recorded on a recording medium by a personal computer and the like and to write the read-out data on other recording media. Accordingly, in a system for protecting a copyright of content, the system must have an effective function to prevent a likely act by a regular user who reads out data on a recording medium and writes them on the other recording medium. In order to achieve such an objective, there is a technology called a media bind which prevents a playback of content by recording the content associating with each recording medium (for example, refer to patent publication No. 3073590). The media bind technology is a technology to encrypt content with a media ID (MID) recorded in a non-rewritable area of a recording medium.

As a specific example of a content protection system which has a function of the key revocation technology or the media bind technology, there is a content protection for recording media (CPRM) recording method which is used for a DVD-RAM and the like.

Conventionally, a recording apparatus corresponding only to a CPRM recording method as a content protection system exists. FIG. 13 is an explanatory diagram for a recording apparatus 1301 corresponding to a conventional single content protection system.

The recording apparatus 1301 is an apparatus for recording content on a recording medium 1303 and the like after receiving the content from broadcasting, a DVD, and the like, and includes a recording method selection unit 1302. The recording method selection unit 1302 selects a type of a source out of either a content protection content (CP content) in order to protect a copyright or a content which does not require the content protection (Non-CP content), and whether or not record content by the CPRM recording method according to types of the recording medium 1303 or 1304.

The recording method selection unit 1302 selects a recording method according to a type of a source and selects the CPRM recording method when the content requires a content protection, and selects the Non-CP recording method when the content does not require a content protection.

Also, the recording method selection unit 1302 selects a recording method according to a type of a recording medium such as the recording medium 1303. Since a media ID (MID) and a key revocation data (KRD) are written on the recording medium 1303, the recording method selection unit 1302 selects to register content by either the CPRM recording method or the Non-CP recording method which does not provide a content protection.

Since the media ID (MID) and the key revocation data (KRD) are not written on the recording medium 1304, the recording method selection unit 1302 selects to record content by the Non-CP recording method which does not provide a content protection. In addition, a case where the content cannot be recorded from the recording apparatus 1301 onto a recording medium is considered as NG.

Following a progress of recent digital technologies, an introduction of a plurality of content protection systems for content distributions other than the above-mentioned conventional content protection system has been scheduled as mentioned above. In such a situation, it is necessary for a recording apparatus and a playback apparatus to correspond to new content protection systems other than the conventional content protection system such as the above-mentioned CPRM recording method. That is, a recording apparatus which is available for the plurality of content protection systems including the conventional content protection system and new content protection systems is required.

However, the above mentioned recording apparatus 1301 is, for example, a recording apparatus which corresponds to single content protection recording method such as the CPRM recording method; there is no recording apparatus which can correspond to a plurality of content protection recording methods corresponding to the conventional content protection system and new content protection systems which are expected to be introduced.

On the other hand, there are playback apparatuses which can operate corresponding to a plurality of content protection systems. Specifically, the present DVD-RAM recorder can play back content supporting both content protection systems for the CSS recording method and the CPRM recording method.

As a consequence, an introduction of a multi-disk corresponding to the plurality of content protection systems by a single disk along with an advancement of the content protection system is expected. However, a conventional disk is a disk which corresponds to a single content protection system so that the content protection system which realizes a transfer and a copying of content between a server apparatus and a recording apparatus using the multi-disk corresponding to the plurality of content protection systems does not exist.

Furthermore, as a mechanism for realizations of a transfer and a copying of content at home along with the popularization of a domestic network is established, requests for additional content protections in a content distribution are raised.

The present invention aims to solve those problems and its first objective is to provide a recording apparatus which records contents on a recording medium and can operate corresponding not only to the conventional content protection system but also to a plurality of new content protection systems.

In addition, the second objective, when the plurality of content protection recording methods exist, is to provide a content protection system for distributing content efficiently from a server apparatus according to a type of a recording medium on which the content is recorded and a function of a recording apparatus to which the content is distributed.

### DISCLOSURE OF INVENTION

To solve the above mentioned problems, the present invention is a recording apparatus for recording a content which is a digital copyrighted work onto a recording medium, comprising: a content obtainment unit operable to obtain a content provided externally; a content type identification unit operable to identify a type of the obtained content; a recording medium type identification unit operable to identify a type of the recording medium; a recording method selection unit operable to select at least one recording method out of a plurality of recording methods based on the type of the content identified by the content type identification unit and the type of the recording medium identified by the recording medium type identification unit; and a recording unit operable to record the content onto the recording medium according to the selected recording method.

In addition, to solve the problems, the present invention is a content protection system comprising a server apparatus and a terminal apparatus connected via a transmission channel; wherein the server apparatus includes: a readout unit operable to read out an encrypted content and decryption information for decrypting the encrypted content from a recording medium on which the encrypted content and the decryption information are recorded; and a sending unit operable to send the readout encrypted content and decryption information to the terminal apparatus via the transmission channel, and the terminal apparatus includes: a receiving unit operable to receive the encrypted content and the decryption information to be sent via the transmission channel; and a decryption unit operable to decrypt the received encrypted content using the decryption information received, wherein the sending unit sends the decryption information via a secure transmission channel after establishing the secure transmission channel between the server apparatus and the terminal apparatus.

Note that the present invention can be realized not only as the above mentioned recording apparatus, but also as a recording method using the units in the recording apparatus as steps, as well as a program realizes the recording method on a computer. And it should be noted that the program can be distributed via a recording media such as an optical disk and CD-ROM, and transmission media such as a communication network.

### BRIEF DESCRIPTION OF DRAWINGS

These and other objects, advantages and features of the invention will become apparent from the following description thereof taken in conjunction with the accompanying drawings that illustrate a specific embodiment of the invention. In the Drawings:

FIG. 1 is a conceptual diagram showing an overall structure of a CPS-2 recording method used for a content protection system according to the present embodiment,

FIG. 2 is a diagram showing a specific example of each data storing in a recording medium recorded by a playback apparatus of a device key DK_1,

FIG. 3 is a block diagram showing a processing unit of the recording apparatus and a conceptual diagram showing a content recording system for a recording medium of the recording apparatus,

FIG. 4 is an explanatory diagram explaining a selection of the content protection recording method in a recording apparatus,

FIG. 5 is a diagram showing an example of a table for identifying a recording method from types of a recording medium and a source in the recording apparatus,

FIG. 6 is an explanatory diagram for the content protection system according to the present embodiment,

FIG. 7 is a diagram showing a relationship between a type of the recording apparatus to which content is distributed and an encryption method of the content,

FIG. 8 is a flowchart showing a procedure for selecting a recording method of the content on a recording medium in the recording apparatus,

FIG. 9 is a flowchart showing a procedure for determining an encryption method of the content to be distributed to the recording apparatus in a server apparatus,

FIGS. 10A and 10B are reference diagrams for explaining a remote playback and an unauthorized use in copying of the content recorded by the CPS-2 recording method, the content protection recording method according to the present embodiment,

FIGS. 11A and 11B are overall diagrams showing a remote playback and a remote recording of the content by the CPS-2 recording method according to the present embodiment,

FIG. 12 is an explanatory diagram for explaining a conventional key revocation technology,

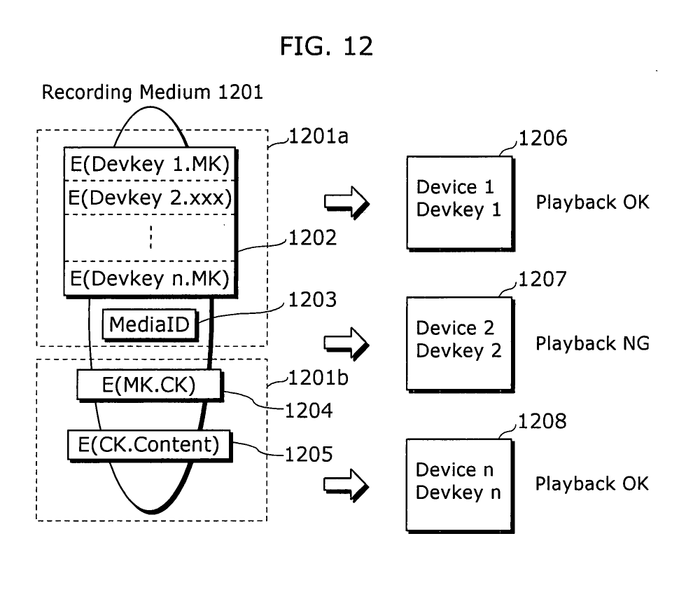

FIG. 13 is an explanatory diagram for a recording apparatus corresponding to a conventional single content protection system, and

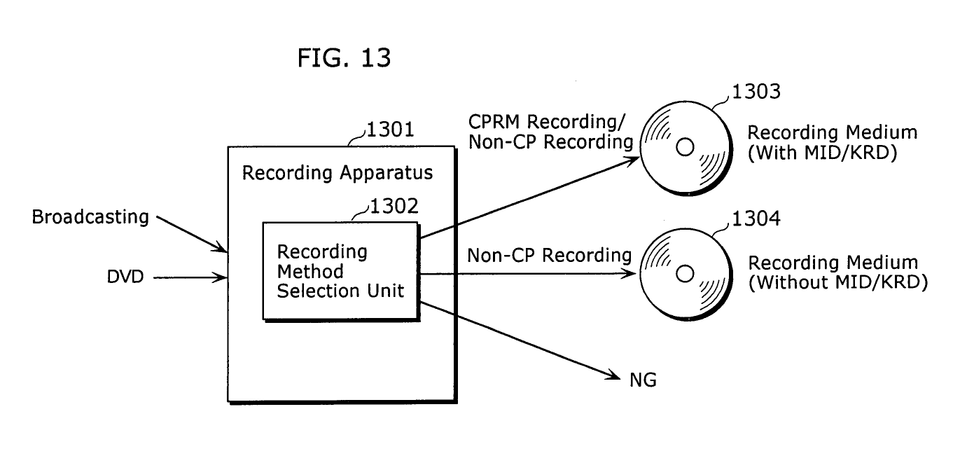

FIG. 14 is a conceptual diagram showing another overall structure of the CPS-2 recording method used for the content protection system.

### BEST MODE FOR CARRYING OUT THE INVENTION

The following describes an embodiment of the present invention according to a recording apparatus and a content protection system with reference to the attached drawings.

### Embodiment

First, a CPS-2 recording method used for the content protection system according to the embodiment which is different from the above-mentioned conventional CPRM recording method is explained. The CPS-2 recording method generates a message authentication code (MAC) with a media ID (MID) which is an individual number for a recording medium.

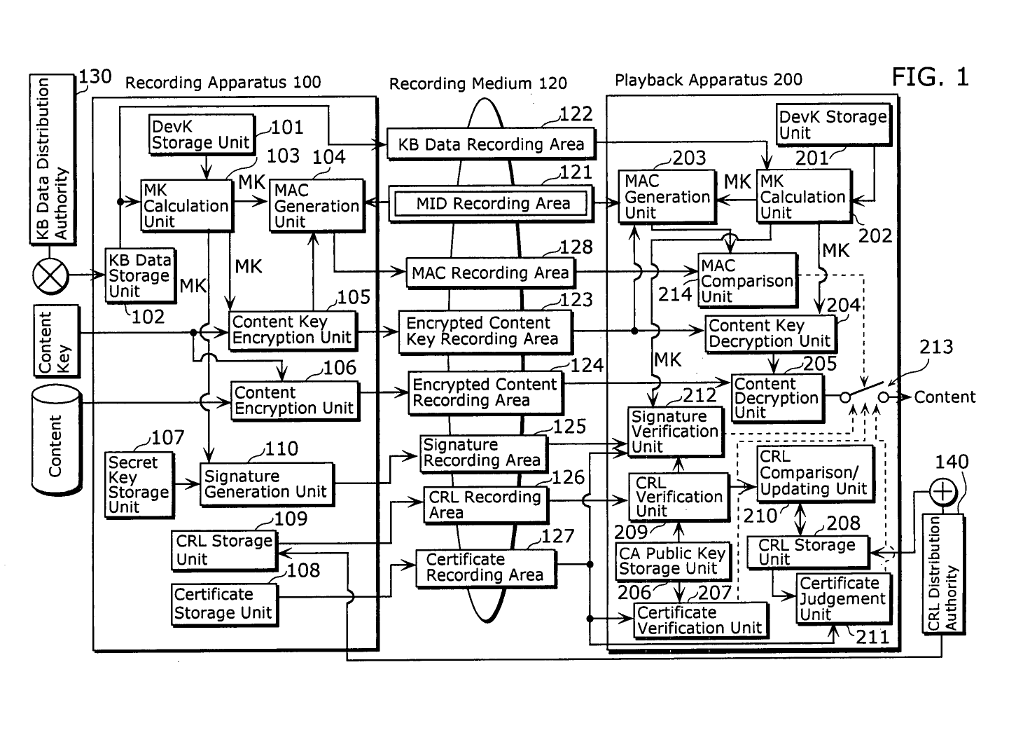

FIG. 1 is a conceptual diagram showing an overall structure of the CPS-2 recording method used for the content protection system according to the present embodiment. FIG. 1 indicates a block diagram showing a structure of a recording apparatus 100 which records information onto a recording medium 120 such as an optical disk, the information recorded from the recording apparatus 100 onto the recording medium 120, a block diagram showing a structure of a playback apparatus 200 which plays back content using the recording medium 120, and a relationship with each processing unit is indicated by arrows.

The recording apparatus 100 includes a device key storage unit 101 which stores a device key that each recording apparatus 100 secretly holds, a key block data storage unit 102 which obtains key revocation block data (hereafter referred to as key block data or as KB) from a key block data distribution authority 130 and stores the key block data, a media key calculation unit 103 which calculates a media key (MK) by decrypting the key block data with a device key, a message authentication code (MAC) generation unit 104 which generates a MAC by inputting the calculated media key at the media key calculation unit 103, an encrypted content key and a MID into a one-way function, a content key encryption unit 105 which encrypts the content key inputted externally by the calculated media key (MK), a content encryption unit 106 which encrypts the content inputted externally by the content key, a secret key storage unit 107 which stores a secret key in a public key cryptosystem, a certification storage unit 108 which stores a certificate authorized with a signature by the central authority (hereafter referred to as CA) for a public key corresponding to the secret key, a CRL storage unit 109 which stores a public key certification revocation list (CRL) showing a latest list of the revoked certifications distributed from a CRL distribution authority 140, a signature generation unit 110 which generates a signature for the media key. According to the content protection system in the present embodiment, a message authentication code (MAC) is information used for judging a validity of content in a playback apparatus 200.

In addition, the recording medium 120 has a media ID recording area 121 in which a media ID is recorded in its non-rewritable area (the area shown in double parentheses) and its rewritable area includes, a key block data recording area 122 in which the recording apparatus 100 records the key block data used for its encryption, an encrypted content key recording area 123 in which an encrypted content key is recorded, an encrypted content recording area 124 in which an encrypted content is recorded, a signature recording area 125 in which the recording apparatus 100 records a generated signature, a CRL recording area 126 in which a CRL held in the recording apparatus 100 is recorded, a certificate recording area 127 in which a certificate is recorded, and a message authentication code recording unit 128 in which a message authentication code generated at the message authentication unit 104 is recorded. According to the present embodiment, in the recording medium 120, only the media ID recording area 121 is written in the non-rewritable area and all other information are written in the rewritable area. Therefore, it makes possible to write the key revocation data into a key revocation data recording area which is the rewritable area in the recording medium 120.

The playback apparatus 200 includes: a device key storage unit 201 which stores a device key secretly held in each apparatus; a media key calculation unit 202 in which a media key (MK) is calculated by decrypting the key block data read out from the recording medium 120 with the device key; a message authentication code generation unit 203 in which a message authentication code is generated according to the one-way function by using following three information: the media key (MK) obtained at the media key calculation unit 202, a media ID obtained in the media ID recording area 121 in the recording medium 120, and the encrypted content key recorded in the encrypted content key recording area of the recording medium 120; a content key decryption unit 204 in which the encrypted content key read out from the recording medium 120 with the calculated media key is decrypted; a content decryption unit 205 in which the encrypted content read out from the recording medium 120 with the decrypted content key is decrypted; a CA public key storage unit 206 in which a public key of the CA is stored; a certification verification unit 207 which verifies the validity of the certificate read out from the recording medium 120 using the public key of the CA, that is, verifying the signature given on the certificate; a CRL storage unit 208 in which the latest CRL to be obtained from the CRL distribution authority 140 is stored; a CRL verification unit 209 which verifies the validity of the CRL read out from the recording medium 120 using the public key of the CA, that is, verifying the signature given on the CRL; a CRL comparison/updating unit 210 which compares old and new of the CRL to be stored in the CRL storing unit 208 with the CRL whose validity is examined after reading out from the recording medium 120 and stores the newest CRL into the CRL storing unit 208; a certification judgement unit 211 which judges whether or not the certificate read out from the recording medium 120 is registered on the newest CRL stored in the CRL storing unit 208; a signature verification unit 212 which verifies a signature read out from the recording medium 120 using the certificate read out from the recording medium 120; and a switch 213 which is controlled based on a result of the judgement and a number of verifications.

Further, the playback apparatus 200 includes a message authentication code (MAC) comparison unit 214 in which a MAC decrypted by the MAC generation unit 203 with a MAC registered in a MAC recording area 128 of the recording medium 120 are compared. In the MAC generation comparison unit 214, it is possible to verify whether or not unauthorized copies via media are prevented and whether a content is written in a recording medium which has a correct MID by sending the result of the comparison of the MACs to the switch 213.

Thus, the CPS-2 recording method for the content protection system according to the present embodiment is allowed to prevent an unauthorized use of content and plan a copyright protection by generating a message authentication code (MAC) with a media ID (MID) in the recording apparatus 100 and comparing message authentication codes in the playback apparatus 200.

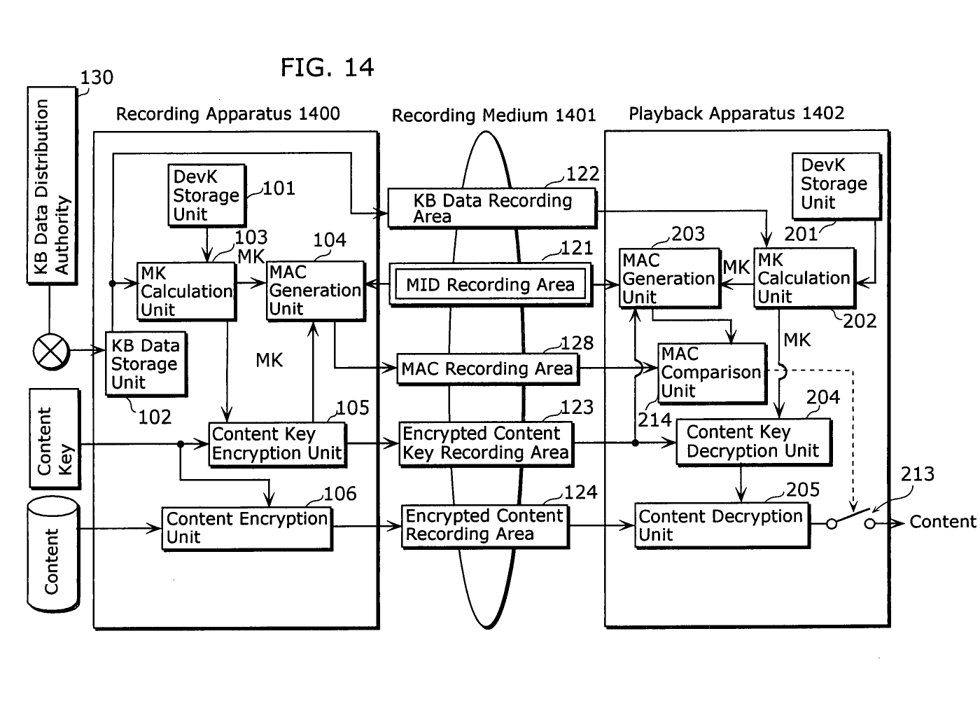

FIG. 14 is a conceptual diagram showing another overall structure of the CPS-2 recording method for the content protection system.

In a recording apparatus 1400, comparing to the recording apparatus 100 described in FIG. 1, the secret key storage unit 107, the certificate storage unit 108, the CRL storage unit 109, and the signature generation unit 110 are removed. Therefore, in a recording medium 1401, recording areas of the signature recording area 125, the CRL recording area 126, and the certificate recording area 127 recorded in the recording medium 120 on FIG. 1 are removed.

Also, in a playback apparatus 1402, comparing to the playback apparatus 200 on FIG. 1, the public key storage unit 206, the certificate verification unit 207, the CRL storage unit 208, the CRL verification Unit 209, the CRL Comparison/Updating Unit 210, the Certificate Judgement Unit 211, and the Signature Verification Unit 212 are removed.

Accordingly, in the content protection system shown in FIG. 14, the recording apparatus 1400 which records content unofficially on a recording medium 1401 cannot be removed. On the other hand, the playback apparatus 1402 can remove a playback of unauthorized content by generating a message authentication code (MAC) with a media ID (MID) and comparing the MAC at the MAC comparison unit 214.

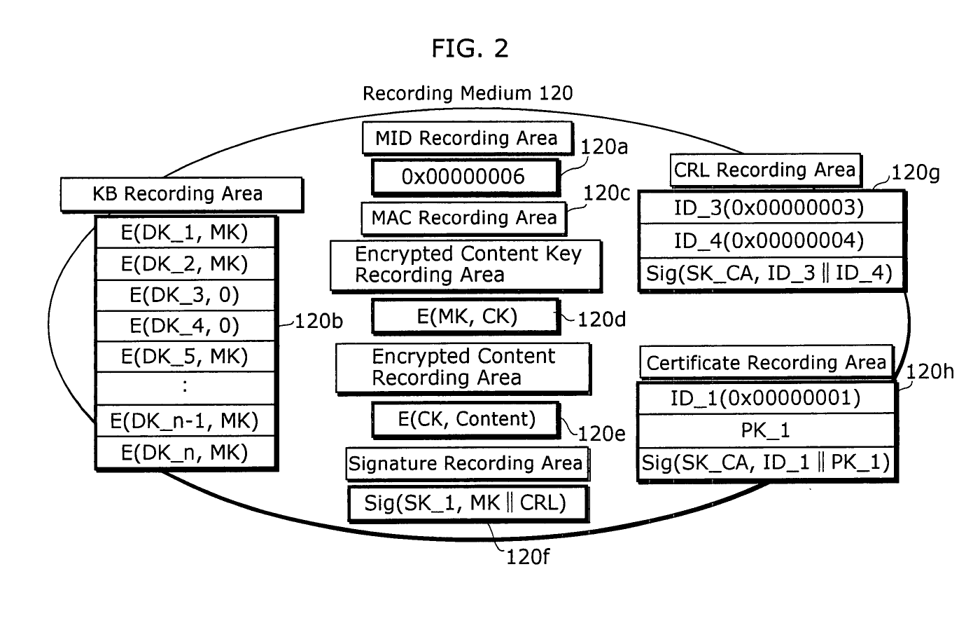

FIG. 2 shows a specific example of each type of data storing in the recording medium 120 recorded by the playback apparatus 200 which has the device key DK_1, when it is assumed that the total number of the playback apparatus 200 is n and the DK_3 and DK_4 are revoked. In this example, each playback apparatus 200 has an individual device key. In addition, FIG. 2 indicates that the MID recording area 120a is the only non-rewritable area in the recording medium 120. (Media ID Recording Area 120a)

A media ID recording area 120a is a non-rewritable area in which a media ID (MID) for each recording medium 120 is recorded. In FIG. 2, the MID is described in hexadecimal number eight digits, and the ID number is “6”. The MID is registered as the recording medium 120 is manufactured and “Ox” shown at the head of the MID indicates that the MID is in hexadecimal number. Further, the MID shown as an example in FIG. 2 is 32 bit.

(Key Block Data Recording Area 120b)

In a key block data recording area 120b, a media key (MK) encrypted by a plurality of device keys (DK) is recorded. Here, E (X, Y) is used to indicate an encryption sentence when key data X encrypted data Y. An encryption algorithm to be used can be realized by technology within the public domain; for example, a DES encryption and the like are used. Furthermore, a device key held in a playback apparatus n is described as DK_n.

In FIG. 2, while the playback apparatuses 200 which has DK_3 and DK_4 respectively are revoked, the data “0” which had no relationship with a media key (MK) is encrypted and recorded on DK_3 and DK_4 held in each apparatus. By generating media key data as above described, all apparatuses except the playback apparatuses 200 which have DK_3 and DK_4 respectively can share a media key (MK) and remove the playback apparatuses 200. Also, other methods for revoking apparatuses may be used. For example, the Japanese Laid-Open Patent application No. 2002-281013 discloses a revocation method using a tree structure.

(Message Authentication Code Recording Area 120c)

In a message authentication code recording area 120c, a message authentication code (MAC) to be generated at the MAC generation unit of the recording apparatus 100 is recorded.

(Encrypted Content Key Recording Area 120d)

In an encrypted content key recording area 120d, a content key (CK) encrypted with a media key (MK) is recorded.

(Encrypted Content Recording Area 120e)

In an encrypted content recording area 120e, an encrypted content with a content key (CK) is recorded.

(Signature Recording Area 120f)

In a signature recording area 120f, signatures generated for a media key (MK) and a CRL are recorded. Here, Sig (X, Y) is used to indicate a signature sentence generated using key data X for data Y. Further, a signature generation algorithm to be used may be realized by technology within the public domain; for example, a RSA signature is used.

In FIG. 2, a signature sentence generated with a secret key (SK_1) of the apparatus 1 is recorded.

(CRL Recording Area 120g)

In a CRL recording area 120g, a CRL subjected when the playback apparatus 200 of DK_1 generates a signature is recorded. The CRL lists IDs of certificates which should be revoked (in here, certificates of the playback apparatuses 200 of DK_3 and DK_4) and given signatures of the CA to those IDs. A signature of the CA is to guarantee the validity of a CRL. Further, a CRL format can be either the one within the public domain or the one identified for a system. Here, ID_3 ∥ ID_4 indicates to connect the ID digits which uniquely identify the playback apparatuses 200 of DK_3 and DK_4.

(Certificate Recording Area 120h)

In a certificate recording area 120h, a certificate corresponding to a secret key (SK_1) used for generating a signature by the playback apparatus 200 of DK_1 is recorded. On the certificate, a certificate ID, a public key (PK_1) and corresponding signatures of the CA are given. A signature of the CA is to guarantee the validity of the certificate. Further, a certificate format can be either the one within the public domain or the one specified for a system.

Next, the following explains operations in each of the recording apparatus 100, the recording medium 120, and the playback apparatus 200 by the CPS-2 method for the content protection system as described above.

In the recording apparatus 100, the media key calculation unit 103 reads out each of a device key and key block data from the device key storage unit 101 and the key block data storage unit 102, and obtains a media key (MK) by decrypting media key data with the device key.

The message authentication code (MAC) generation unit 104 generates a MAC by inputting a media key obtained at the media key calculation unit 103 and an encrypted content key into a one-way function.

The content key encryption unit 105 encrypts a content key inputted externally with the media key calculated at the media key calculation unit 103. The content encryption unit 106 encrypts the content inputted externally with the content key similarly inputted externally. The signature generation unit 110 reads out a secret key from the secret key storage unit 107 and generates a signature for a media key and a CRL.

Then, the recording apparatus 100 records key block data held in the apparatus, a CRL, a certificate, a generated message authentication code, an encrypted content key, an encrypted content, and a signature on a recording medium 120.

Next, operations in the playback apparatus 200 are explained that the playback apparatus 200 reads out a key block data, a media ID, a message authentication code, an encrypted content key, an encrypted content, a signature, a CRL, and a certificate from the recording medium 120.

The media key calculation unit 202 reads out a device key from the device key storage unit 201 and obtains a media key (MK) by decrypting the read out key block data with the device key.

A message authentication code generation unit 203 decrypts a message authentication code (MAC) with the media ID (MID) read out from the recording medium 120, the media key (MK) obtained at the media key calculation unit 202, and the encrypted content key. A message authentication code comparison unit 214 compares a MAC obtained at the message authentication code generation unit 203 with a MAC read out by the recording medium 120. As a result of the comparison, if the MACs are matched, the message authentication code comparison unit 214 sends permission for a content playback to a switch 213.

The content key decryption unit 204 obtains a content key by decrypting the encrypted content key read out from the recording medium 120 with the media key (MK) obtained at the media key calculation unit 202. Further, the content decryption unit 205 obtains content by decrypting the encrypted content read out by the recording medium 120 with the content key obtained at the content key decryption unit 204.

The certificate verification unit 207 reads out a public key of the CA from a CA public key storage unit 206 and verifies the validity of the certificate read out from the certificate recording area 127 in the recording medium 120 with the public key. Then, while the content is not played back opening a switch 123 when the verification for the validity of the certificate is NG, the switch is closed and the content can be played back when the validity of the certificate is OK. Besides, in the present invention, the content is played back closing the switch 213 only when all verifications of the certificate verification unit 207, the certification judgement unit 211 which is described later, the signature verification unit 212, and the message authentication code comparison unit 214 are OK.

A CRL verification unit 209 verifies the validity of the CRL read out in the CRL recording area 126 of the recording medium 120 with the public key of the CA read out from the CA public key storage unit 206.

The CRL comparison/updating unit 210 compares a read out from the CRL storage unit 208 with a CRL read out from the CRL verification unit 209 to know old and new of the CRLs. For example, the old and new comparison uses a version number assigned to a CRL. As a result of this comparison, the CRL judged as newer is stored in the CRL storage unit 208.

The certificate judgement unit 211 judges whether or not the certificate read-out by the recording medium 120 is registered by reading out a CRL from the CRL storage unit 208. As a result of the judgement, the content is not played back opening the switch 213 when the certificate is registered. On the other hand, content is played back closing the switch 213 when the certificate is not registered.

The signature verification unit 212 verifies the validity of the signature read out from the signature recording area 125 in the recording medium 120 using the certificate read out similarly from the recording medium 120, the CRL to be read out from the CRL verification unit 209, and the media key (MK) generated at the media key calculation unit 202. As the result, the content is not played back opening the switch 213 when the validity of the signature is NG. On the other hand, the content is played back closing the switch 213 when the validity of the signature is OK.

Thus, on the CPS-2 recording method for the content protection system according to the present embodiment, the recording apparatus 100 generates a message authentication code (MAC) with a media ID (MID) and records it on the recording medium 120, and together with in the playback apparatus 200, the validity of the MAC is allowed to be verified with the MID. Since the playback apparatus 200 cannot play back the content when the MAC is not validated, the content protection can be realized by preventing the content use by unauthorized acts such as copying. In addition, the playback apparatus 200 can remove unauthorized recording apparatuses 100 using CRLs.

The above explained the CPS-2 recording method for the content protection system according to the present embodiment. Next, the recording apparatus 100 and the content protection system according to the present invention are explained.

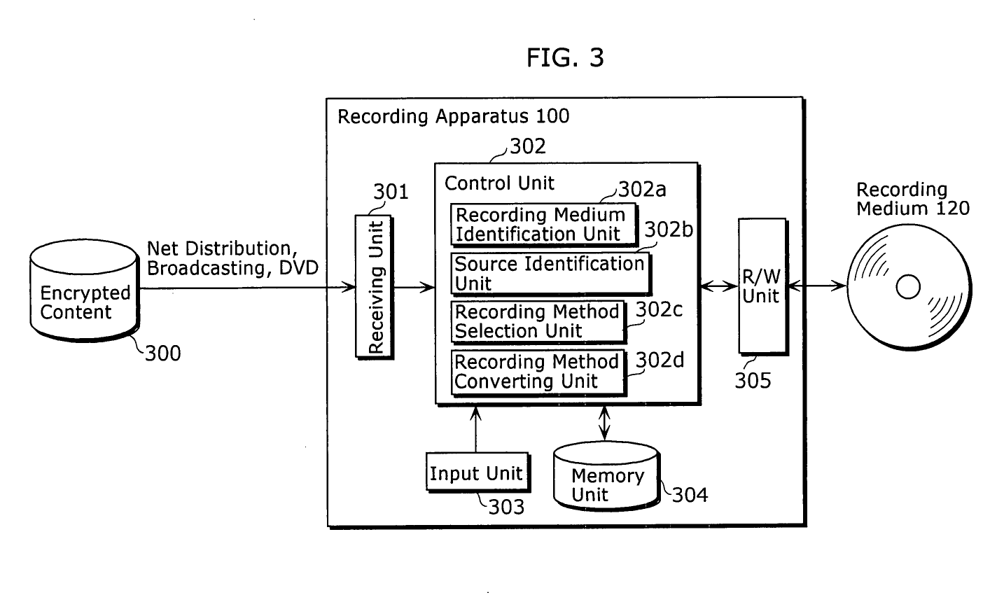

FIG. 3 is a block diagram showing a processing unit of the recording apparatus 100 according to the present invention and a conceptual diagram showing a content recording system of the recording apparatus 100 to the recording media 120. Moreover, the recording apparatus 100, for example as a DVD recorder, records content on a recording medium 120 which is able to correspond to a plurality of the content protection methods.

Further, as the plurality of the content protection recording methods according to the present embodiment, three methods of the conventional CPRM recording method, the above-mentioned CPS-2 recording method according to the present embodiment, and a Non-CP recording method are used for an explanation. However, the recording apparatus 100 does not limit to these three methods, but it is adoptable to the plurality of recording methods using other content protection systems.

The recording apparatus 100 includes a receiving unit 301 at which content is received, a control unit 302 in which a recording method of content on the recording media 120 is determined, an input unit 303 such as a key board equipped to the recording apparatus 100 by which users can input, a memory unit 304 which is a memory unit recording contents and the like, and a R/W unit 305 which is able to write in and read out on the recording medium 120.

The receiving unit 301 receives an encrypted content via a net distribution, a digital broadcasting, a DVD, and the like. In addition, the control unit 302 includes: a recording medium identification unit 302a which identifies whether the recording medium 120, via the R/W unit 305, is able to correspond to a CPRM recording method, a CPS-2 recording method, or a Non-CP recording method; a source identification unit 302b which identifies a type of the source based on whether the received content is for the content protection or not; a recording method selection unit 302c which selects the content protection method by the recording apparatus 100 on the recording medium 120 out of the CPRM recording method, the CPS-2 recording method, or the Non-CP recording method; and a recording method conversion unit 302d which coverts these three recording methods.

The input unit 303 such as a keyboard inputs a selection of a content protection recording method by a user of the recording apparatus 100 on the recording medium 120 of the content. Further, the memory unit 304 is a hard disk memorizing the encrypted content 300 and the like which the receiving unit 301 received.

The R/W unit 305 writes content and the like on the recording medium 120 complying with an instruction of a recording method of the content protection system by the control 302. Specifically, a writing process of the R/W unit 305 on the recording medium 120 complying with one or a plurality of the recording methods to be selected out of the CPRM recording method, the CPS-2 recording method, and Non-CP recording method. Also, the R/W unit 305 reads out whether the recording medium 120 has key block data and a media ID (MID), and sends the readout result to the recording media identification unit 302a. Then, the recording method identification unit 302c decides a recording method on the recording media 120 of the content complying with information from the recording media identification unit 302a and the source identification unit 302b, sends the determined method to the R/W unit 305, and the R/W unit 305 records the content by the recording method on the recording medium 120.

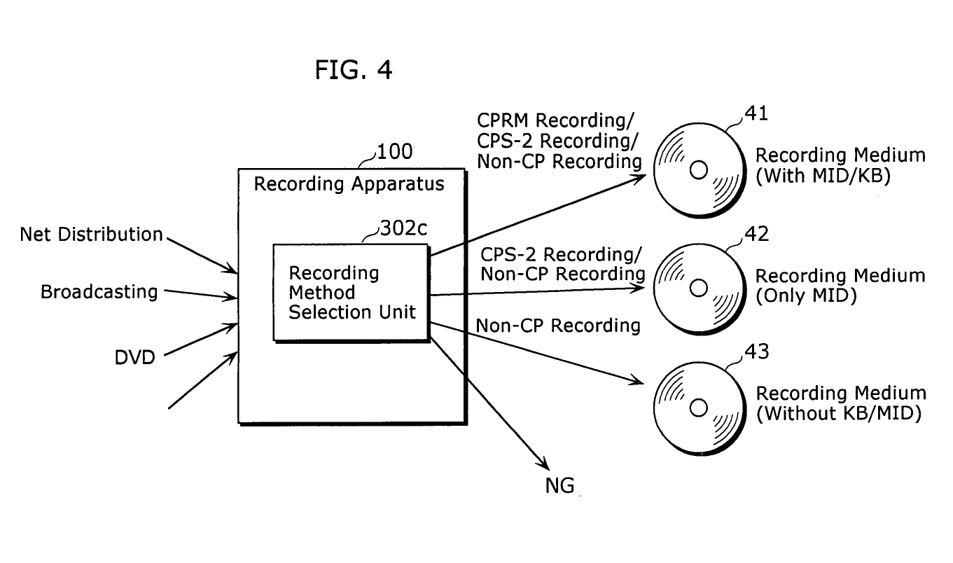

FIG. 4 is an explanatory diagram to select a content protection recording method in the recording apparatus 100 according to the present invention. The recording apparatus 100 shown in FIG. 4 is the same recording apparatus 100 shown in the FIG. 3.

The recording apparatus 100 is an apparatus for recording information such as a received content by selecting a recording method for the recording media 41 and the like of a plurality of contents used for the content protection system.

In FIG. 4, there are three types of recording media. They are a recording medium 41 that a media ID (MID) and key block data (KB) are written in its non-rewritable area, a recording medium 42 that only the MID is written in its non-rewritable area, and a recording medium 43 in which neither the MID nor the KB are written.

Consequently, the recording medium 41 is allowed to correspond to all three content protection recording methods: the CPRM recording method which requires both MID and KB, the CPS-2 recording method which requires only MID, and the Non-CP recording method which does not provide a content protection; the recording medium 42 is allowed to correspond to two of the content protection recording methods: the CPS-2 recording method and the Non-CP recording method; and the recording medium 43 is allowed to correspond only to the Non-CP recording method. Accordingly, the recording method selection unit 302c in the recording apparatus 100 is allowed to select a recording method of content according to the types of the recording medium 41 and the like. In addition, it is shown as NG when content cannot be recorded on a recording medium by the recording apparatus 100.

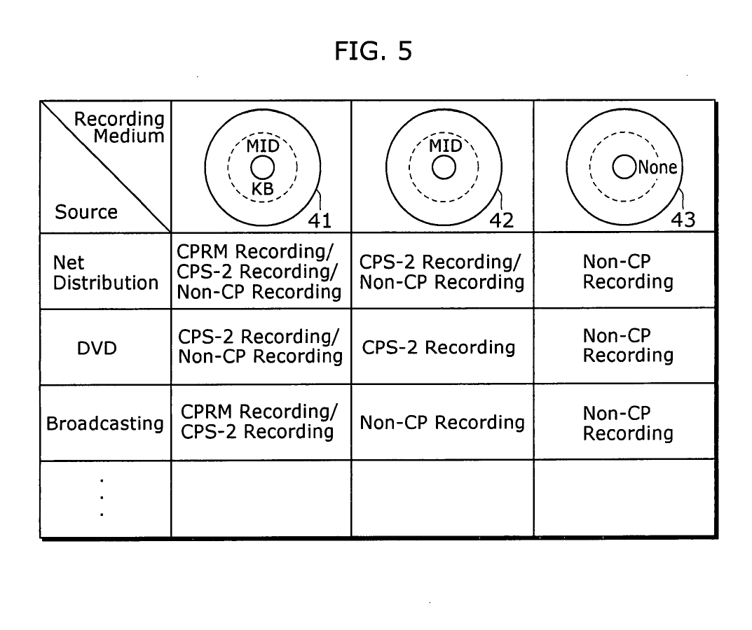

FIG. 5 is a diagram showing an example of a table for identifying a recording method 100 from types of a recording medium and a source in a recording apparatus according to the present invention. This table is held in the memory unit 304 of the recording apparatus 100 as re-writable.

In FIG. 5, the recording apparatus 100 is shown that its type of a recording medium is a recording medium 41 that a media ID (MID) and a key block (KB) Data are written in its non-rewritable area, and in the case where the type of its receiving source is a net distribution, the recording apparatus 100 selects its content recording method on the recording medium 41 out of three recording methods: the CPRM recording method, the CPS-2 recording method, and the Non-CP recording method. Thus, the recording apparatus 100 corresponds to a multi-disk on which content can be recorded according to a plurality of the recording methods.

Furthermore, in the case of where the type of a recording medium is the recording medium 43 in which a media ID (MID) and a key block Data (KB) are not written, it is shown that only the Non-CP recording method is allowed to be selected regardless of the types of sources since the playback apparatus 200 cannot verify the validity of content.

In addition to DVD, the recording medium 120 which can store contents more than the recording apparatus 100 used for the present embodiment are CD-R/RW and BD (Blu-ray Disc) which are expected to be used.

A content protection recording method in the recording apparatus 100 which is basically determined by the side of the recording apparatus 100 can also be selected from the methods such as a method that a content provider gives an instruction by setting a flag on the content and the recording apparatus 100 records the content on the recording medium 120 in a recording method which followed the instruction, and a method that a user of the recording apparatus 100 selects a recording method out of a plurality of recording methods via the input unit 303 such as a keyboard according to a function of the recording apparatus 100.

In addition, in the case where the plurality of the content protection recording methods exist, it is assumed that the recording apparatus 100 selects a recording method according to a security level, quality of the content and the like to be sent since each recording method has a different security level. For example, when the recording apparatus 100 corresponds to the plurality of the recording methods, the CPS-2 recording method has a higher security level than the CPRM recording method, and high security level is required for recording the content, the CPS-2 recording method is used for recording the content. In here, the quality of content is sound quality, picture quality, and the like. For example, a predetermined recording method is adopted for high definition movie content.

It is also possible that the recording method is selected according to a type of an input channel, in the case where the recording apparatus 100 which obtains the encrypted content 300 has the plurality of input channels such as broadcasting, Internet, CATV, DVD (Pre-recorded DVD (content for sale) and DVD-RAM (content for self-recording)).

Furthermore, for example, in the case where the recording apparatus 100 according to the present invention corresponds to the two types of content protection methods of the CPRM recording method and the CPS-2 recording method, it is possible to re-record the content, which is recorded on the recording medium 120 by the CPRM recording method, by converting it into the CPS-2 recording method in the recording method conversion unit 302d. Thus, it is conceivable that the recording apparatus 100 not only converts the content from a recording method into another recording method, but also records the content on the recording medium 120 adding another new method to the pre-recorded recording method. Consequently, recording a single content by both of the CPRM recording method and the CPS-2 recording method allows the playback apparatus 200 which corresponds to only one of the recording methods to use the recording medium 120 which records the content.

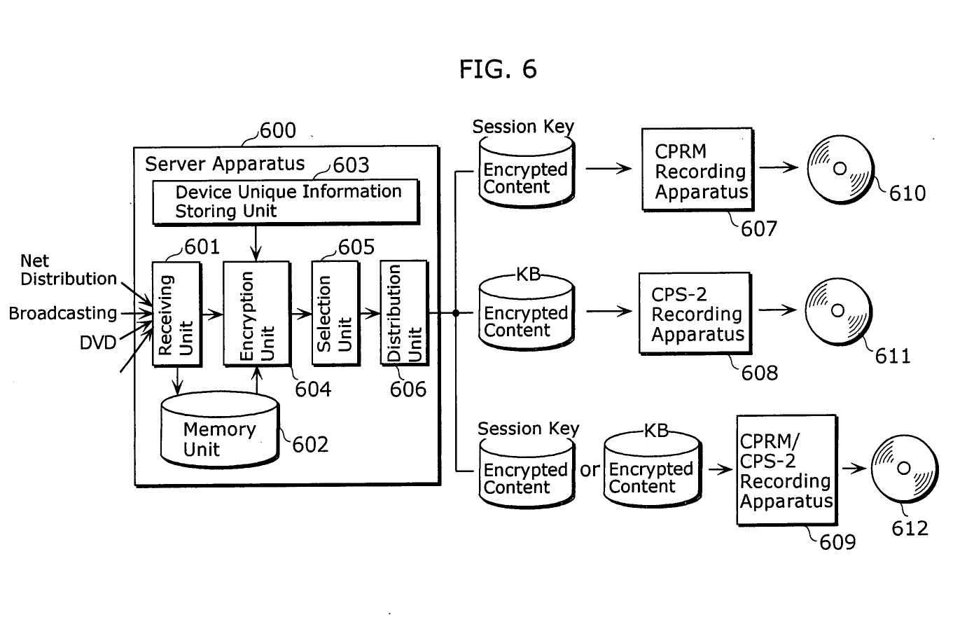

FIG. 6 is an explanatory diagram of the content protection system according to the present embodiment. A server apparatus 600 receives content from various sources such as net distribution, broadcasting, and DVD. The server apparatus 600 is a standard server apparatus or a domestic server apparatus.

In FIG. 6, the recording medium on which content is recorded from a recording apparatus 607 and the like, for example a DVD-RAM disc, can support both the CPRM recording method and the CPS-2 recording method. Therefore, a recording medium 610, 611, and 612 are multi-disks which can correspond to the plurality of the content protection systems on one disk. Also, the server apparatus 600 which is a content distribution source according to the present embodiment distributes content according to an ability of a recording apparatus for a receiver of the distribution and a type of a recording medium on which the content is recorded. A conventional recording medium on one disk corresponds only to an individual content protection system so that there is no multi-disk which realizes a content transfer and a copying corresponding to the plurality of the content protection systems.

The server apparatus 600 is connected to three types of recording apparatuses via a network: a recording apparatus 607, a recording apparatus 608, and recording apparatus 609. The recording apparatus 607 corresponds to the CPRM, the recording apparatus 608 corresponds to CRS-2, and the recording apparatus 609 is a recording apparatus which available for both the CPRM and CPS-2.

Furthermore, the server apparatus 600 includes: a receiving unit 601 at which an encrypted content is received, a memory unit 602 in which received content and the like are memorized, an apparatus unique information storing unit 603 in which apparatus unique information is written when the server apparatus 600 is manufactured, an encryption unit 604 in which content is encrypted using the apparatus unique information and key revocation data, a selection unit 605 in which an encryption method of the content according to the ability of a recording apparatus of the content to which the content is distributed and a type of a recording medium, and a distribution unit 606 which distributes the encrypted content to the recording apparatus 607.

First, when the recording apparatus 607 corresponds to the CPRM, the selection unit 605 selects to distribute content to be distributed after encrypting it with a session key. Then, the server apparatus 600 decrypts the content encrypted with the apparatus unique information from the encryption unit 604 with the apparatus unique information obtained at the apparatus unique information storing unit 603. After that, the server apparatus 600 and the recording apparatus 607 share the session key after processing authorizations each other, encrypt the decrypted content with the session key and send the content to the recording apparatus 607 via the distribution unit 606.

Then, when the recording apparatus 608 corresponds to the CPS-2, the selection unit 605 selects to distribute after encrypting the content to be distributed with key block data (KB). The server apparatus 600 encrypts the content based on the key block data (KB) and sends it to the recording apparatus 608 via the distribution unit 606.

When the recording apparatus 609 corresponds to the CPRM/CPS-2, the selection unit 605 selects to distribute after encrypting the content to be distributed with the session key or the key block data (KB). Then the server apparatus 600 encrypts the content with the session key or the key block data at the encryption unit 604 and distributes to the recording apparatus 609 via the distribution unit 606.

Thus, the content protection system according to the present embodiment, the server apparatus 600 is allowed to select an encryption method of the content according to the ability of the recording apparatus to which the content is distributed and a type of a recording medium to realize more effective content distribution.

In addition, the content protection system according to the present embodiment allows to perform more effective content distribution not only on a conventional single disk corresponding to the CPS, but also on a content transfer and a copying using a multi-disk corresponding to a plurality of the content protection recording methods which expected to be introduced, while providing a content protection.

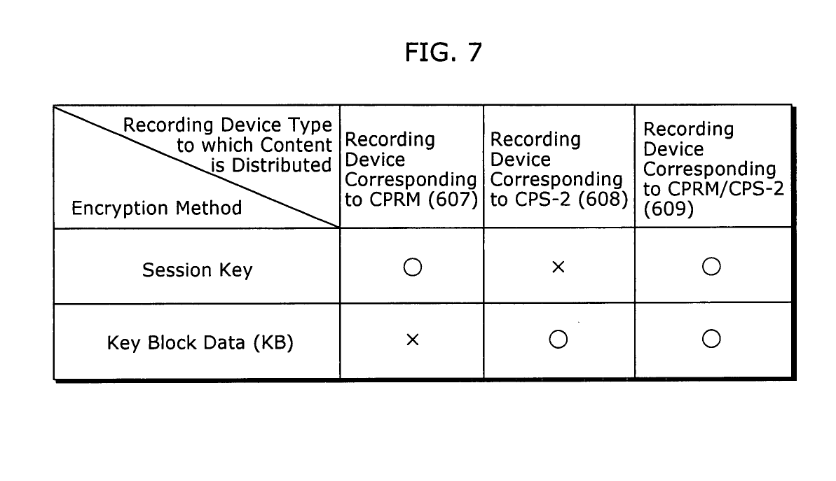

FIG. 7 is a diagram showing a relationship between a type of a recording apparatus to which the content is distributed and an encryption method for the content. The table is rewritable in the memory unit 602 of the server apparatus 600. It should be noted that the table shown in FIG. 7 is an example. Therefore, the present invention does not limit its function to this.

FIG. 7 shows that in the recording apparatus corresponding to CPRM (607), a session key is used for the encryption method of the content to be distributed from the server apparatus 600 to the recording apparatus 607; in the recording apparatus corresponding to CPS-2 (608), key block data (KB) is used for the encryption method of the content to be distributed from the server apparatus 600; and in the recording apparatus corresponding to CPRM/CPS-2 (609), both session key and key block data (KB) are available for the encryption method of the content to be distributed from the server apparatus 600. In addition, the session key can be used to send even when the recording apparatus is corresponding to CPS-2.

In FIG. 6, it is possible that after the recording apparatus 607 and the like read out a media ID (MID) written in a non-rewritable area in the recording media 610, the MID is sent to the server apparatus 600, and the server apparatus 600 generates the message authentication code (MAC) and sends the MAC to the recording apparatus 607 and the like.

It is also possible that a user of the recording apparatus 607 and the like specifies a format of an encryption of content to be distributed by the server apparatus 600 when the recording apparatus 607 and the like are corresponding to the plurality of the content protection systems. Further, a manager of the server apparatus 600 may also specify the format.

Furthermore, the server apparatus 600 may re-encrypt the content to be distributed according to an instruction from the recording apparatus 607 when an accumulation format for the content memory unit 602 and an encryption format of the content specified by the recording apparatus 607 and the like differ.

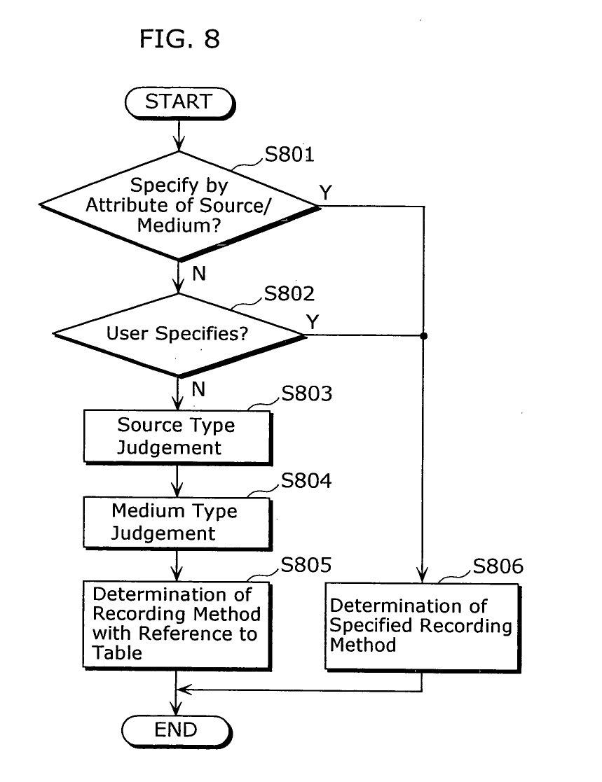

Next, operations for selecting a recording method for the content protection system in the recording apparatus 100 are explained. FIG. 8 is a flowchart showing a procedure for selecting a recording method on the recording medium 120 of content in the recording apparatus 100 according to the present invention.

First, the recording apparatus 100 receives content and specifies the recording method from the types of sources such as net distribution and DVD, determines whether or not it is a content protection content, or whether or not a recording method of the content on the recording medium 120 is specified by the type of the recording medium 120 reading a recording medium (S801). When the recording method is specified (S801 Y), the recording method is determined as the specified recording method (S806).

Next, when the recording method is not specified (S801 N), the recording apparatus 100 determines whether or not a user specifies a recording method of content on the recording media 120 via the input unit 303 such as a key board (S802). Then, when the method is specified (S802 Y), the method is determined as the specified recording method (S806). On the other hand, when the method is not specified (S802 N), the recording apparatus 100 judges a type of sources such as net distribution, DVD, and broadcasting (S803).

After that, the recording apparatus 100 judges a content protection system corresponding to a type of the recording medium 120 by reading the recording medium 120 (S804). Then, the recording apparatus 100 determines a recording method with reference to a table shown in above-described FIG. 5 to determine a recording method of the content on the recording medium 120 according to types of a medium and a source (S805).

Accordingly, the recording apparatus 100 in the present invention is allowed to select one or more of appropriate recording methods out of the plurality of the content protection systems according to an ability of the recording apparatus 100 and a type of the recording medium 120, that generates the recording apparatus 100 which is able to correspond to the plurality of the content protection systems.

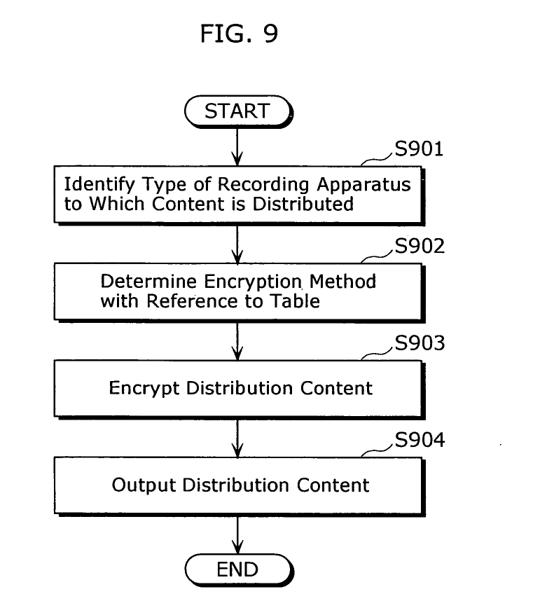

FIG. 9 is a flowchart indicating a procedure for determining an encryption method of the content to be distributed to the recording apparatus 607 and the like in the server apparatus 600.

First, the server apparatus 600 identifies a type of the recording apparatus 607 and the like to which the content is distributed. Specifically, it identifies a type out of methods which correspond to CPRM, CPS-2, or CPRM/CPS-2 as shown in FIG. 7(S901).

Next, the server apparatus 600 determines an encryption method for the content with reference to the table shown in FIG. 7 (S902). Then, the server apparatus 600 encrypts the content to be distributed according to the determined encryption method (S903), and outputs the distribution content via the distribution unit 606 (S904).

Consequently, the server apparatus 600 which is a distributor of content is allowed to distribute the content according to the ability of the recording apparatus 607 or the like to which the content is distributed, and that realizes more effective content distribution allowed to correspond to the plurality of the recording methods.

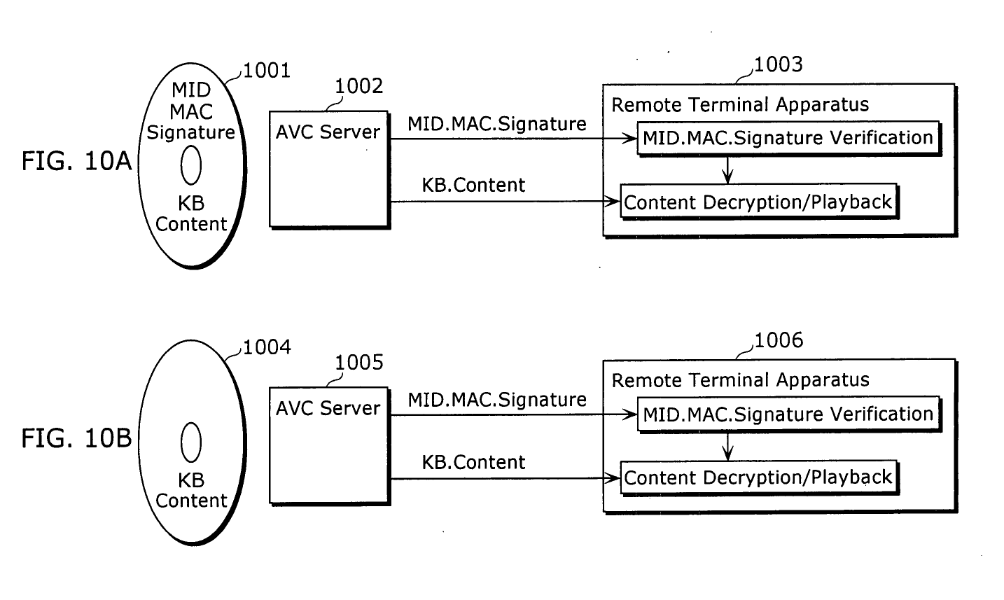

FIG. 10 is a reference diagram for explaining unauthorized use of the content in remote playback and copying, the content being recorded by the CPS-2 recording method, the content protection recording method according to the present embodiment.

In FIG. 10, an AVC server 1002, for example a server apparatus at home, distributes an encrypted content to a remote terminal apparatus 1003 by wireless and the like. FIG. 10A explains an authorized remote playback and FIG. 10B explains an unauthorized remote playback of content using an unauthorized recording medium 1004 which performs a copying of a recording medium 1001 and the like.

On the recording medium 1001, a media ID (MID) which is an identification number written in its non-rewritable area for each recording medium, and a message authentication code (MAC), a signature, key block data (KB), and content are written in its rewritable area. The AVC server 1002 sends a MID, a MAC, and a signature to the remote terminal device and the remote terminal apparatus 1003 verifies whether or not there is unauthorized use of content. In addition, the remote terminal apparatus 1003 receives key block data (KB) and content sent by the AVC server 1002 decrypts and plays back the content.

On the other hand, when content is used by the recording medium 1004 which performs unauthorized copying, it is usually possible to prevent an unauthorized use of content in the CPS-2 recording method because a MID for each recording medium as manufactured differs. However, in FIG. 10B, it is possible that the MID is rewritten to a legitimate MID on a communication channel owing to a remote playback by wireless and the like. In this case, content which is sent from an AVC server 1005 to a remote playback terminal 1006 can be used without an authorization. That is, it is conceivable that a MID of the content recorded on the recording medium 1004 by the CPS-2 recording method is obtained without an authorization on wireless network when the content is remotely played back at home.

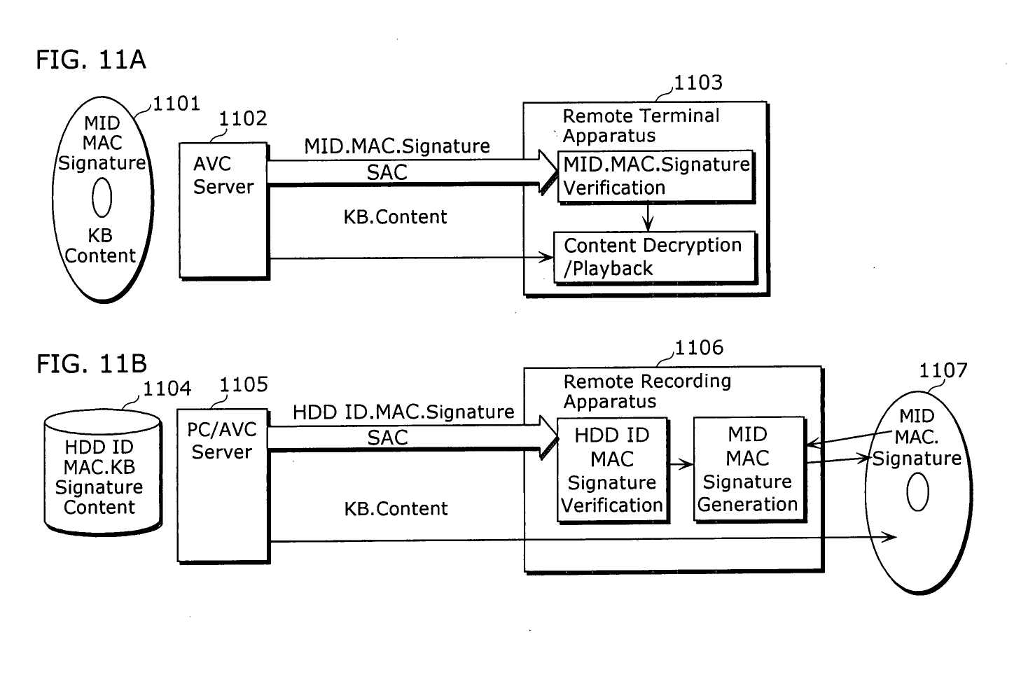

In order to solve the above-mentioned problem, a secure authentication channel (SAC) is established on a communication channel to secure the communication channel according to the present embodiment. FIG. 11 is an overall diagram showing a remote playback and a remote recording of content using the CPS-2 recording method according to the present embodiment.

In FIG. 11A, a media ID (MID), a message authentication code (MAC), and a signature are sent to a remote playback apparatus 1103 from an AVC server 1102 after the SAC is established to prevent a rewrite of the MID shown in FIG. 10B on the communication channel.

Also, FIG. 11B is an explanatory diagram describing a case when content is sent to a remote recording apparatus 1106 from a PC/AVC server 1105. In here, HDD ID which is an identification number for a hard disk 1104 is used as information corresponding to a MID of a recording medium. Then, the PC/AVC server 1105 sends a HDD ID, a MAC, and a signature to a remote recording apparatus 1106 after the communication channel is encrypted by the SAC and the like as shown in FIG. 11A. In addition, the MAC is generated at the PC/AVC server 1105 using the HDD ID.

Therefore, in the present embodiment, the remote recording apparatus 1106 can securely send the HDD ID to the remote recording apparatus 1106 through the SAC which prevents the rewrite of the HDD ID on the communication channel and it records a MAC and a signature on a recording medium 1107 after reading out a MID from the recording medium 1107 and generating a MAC and a signature which correspond to the MID, together with recording a key block data (KB) and content directly on the recording medium 1107. Therefore, the remote recording apparatus 1106 needs to perform both a verification process and a generation process.

Further, in FIG. 11, use of IDs of a PC and a PC application as a substitute for the HDD ID sent from the PC/AVC server 1105 to the remote recording apparatus 1106 is also considered. In a communication where the remote recording apparatus 1106 verifies the PC/AVC server 1105 separately, an HDD ID, a MAC, and a signature are not necessarily sent. In addition, it is needless to say that the SAC is not required when a recording is performed on the recording apparatus such as DVD double drive.

Consequently, also in the case where content is distributed to a remote terminal apparatus 1103 and the like, a server can securely distribute content to the remote terminal apparatus 1103 and a remote recording apparatus 1106 by establishing a SAC on a communication channel so that an unauthorized server apparatus cannot have a SAC which prevents a rewrite of a MID and an HDD ID on the communication channel.

While, in the above mentioned present embodiment, the CPRM recording method, the CPS-2 recording method, and the Non-CP recording method are used to explain as recording methods for content and the like used in a content protection system, the content protection recording system available for the present invention is not limit to these methods. That is, the recording apparatus 100 of the present invention is allowed to record on a recording medium of content capable for corresponding to a plurality of the content protection system.

As is clear from the above explanation, a recording apparatus according to the present invention is a recording apparatus recording content which is a digital copyrighted work on a recording medium based on a content obtainment unit which obtains content provided externally; a content type verification unit which verifies a type of the received content; a recording medium type verification unit which verifies a type of the recording medium; the content type verified by the content type verification unit; and the recording medium type verified by the recording medium type verification unit, the recording method comprising a recording method selection unit which selects at least one of recording methods out of the plurality of the content protection system, and a recording unit which records the content on the recording medium according to the selected recording method.

Therefore, the recording apparatus is allowed to select a recording method for a recording medium of content out of the plurality of recording methods according to types of a recording medium and content.

Also, a recording method according to the present invention, wherein the content obtainment unit sends the obtained content to the recording unit via a transmission channel; the recording unit records the received content via the transmission channel to the recording medium; and the content obtainment unit sends an encrypted content to the recording unit after encrypting the content according to a recording method adopted by a recording unit to be distributed.

As a consequence, a server apparatus selects a distribution method of content according to a recording apparatus to which the content is distributed and a type of a recording medium to be recorded. Accordingly, the server apparatus which is a distributor of content is allowed to distribute content according to an ability of a recording apparatus to which the content is distributed or the type of a recording medium on which the content is recorded, and more effective content distribution is realized.

Further, the content protection system according to the present invention, is a content protection system composed of a server apparatus and a terminal apparatus connected via a transmission channel which comprises a read out unit which reads out an encrypted content and a decryption information from a recorded medium on which an encrypted content and decryption information required for decrypting the encrypted content; and a sending unit which sends the read out encrypted content and the decryption information to the terminal apparatus via the transmission channel; wherein the terminal apparatus comprises a receiving unit which receives an encrypted content and decryption information to be sent via the transmission channel, and a decryption unit which decrypts the received encrypted content by the received decryption information; wherein the sending unit which sends the decryption information via the transmission channel after establishing a secure transmission channel between the terminal apparatus.

Consequently, when content is distributed to a remote terminal apparatus, a safe content distribution to the remote terminal apparatus is realized by establishing a secure authentication channel (SAC) which prevents a rewrite of a media ID (MID) on the communication channel.

1. A recording apparatus for recording a content which is a digital copyrighted work onto a recording medium, comprising:
a content obtainment unit operable to obtain a content provided externally;
a content type identification unit operable to identify a type of the obtained content;
a recording medium type identification unit operable to identify a type of the recording medium;
a recording method selection unit operable to select at least one recording method out of a plurality of recording methods based on the type of the content identified by the content type identification unit and the type of the recording medium identified by the recording medium type identification unit; and
a recording unit operable to record the content onto the recording medium according to the selected recording method.

2. The recording apparatus according to claim 1,
wherein the content type identification unit identifies, as the type of the content, at least one of a first type in which the content is provided through a transmission medium and a second type in which the content is provided by the recording medium.

3. The recording apparatus according to claim 1,
wherein the recording medium type identification unit identifies the type of the recording medium according to a type of information previously stored in a non-rewritable area of the recording medium.

4. The recording apparatus according to claim 1,
wherein the recording method selection unit selects said one recording method out of the plurality of recording methods compliant with a method for protecting a copyright of a content.

5. The recording apparatus according to claim 1,
wherein the recording method selection unit further selects said one recording method out of the plurality of recording methods based on an instruction from a provider of the content.

6. The recording apparatus according to claim 1,
wherein the content includes specification information for specifying said one recording method out of the plurality of recording methods; and
the recording method selection unit further selects said one recording method out of the plurality of recording methods based on the specification information included in the content.

7. The recording apparatus according to claim 1,
wherein the recording method selection unit further selects said one recording method out of the plurality of recording methods based on an instruction by a user.

8. The recording apparatus according to claim 1,
wherein the recording method selection unit further selects said one recording method out of the plurality of recording methods based on a security level required for the content.

9. The recording apparatus according to claim 1,
wherein the recording method selection unit further selects said one recording method out of the plurality of recording methods based on quality of the content.

10. The recording apparatus according to claim 1,
wherein the content obtainment unit includes a plurality of input channel units, each corresponding to a type of data to be obtained, and
the recording method selection unit further selects said one recording method out of the plurality of recording methods according to which one of the plurality of the input channel units has obtained the content.

11. The recording apparatus according to claim 1,
wherein the recording unit records a second content by a second recording method on the recording medium while retaining a first content, when the first content is recorded on the recording medium by a first recording method.

12. The recording apparatus according to claim 1,
wherein a first content is recorded onto the recording medium by a first recording method, and
the recording apparatus further records the first content by a second recording method onto the recording medium after reading out the first content from the recording medium.

13. The recording apparatus according to claim 1,
wherein the recording method selection unit selects two or more recording methods out of the plurality of recording methods, and
the recording unit records the content onto the recording medium according to the selected two or more recording methods.

14. The recording apparatus according to claim 1,
wherein the content obtainment unit sends the obtained content to the recording unit via a transmission channel,
the recording unit records the content received via the transmission channel onto the recording medium, and
the content obtainment unit encrypts the content according to a recording method adopted by a recording unit that is a destination of the transmission and sends the encrypted content to the recording unit.

15. The recording apparatus according to claim 14,
wherein the recording method includes a first recording method and a second recording method compliant with the method for protecting a copyright of a content, and
the content obtainment unit encrypts the content with a previously held secret key when the recording unit adopts the first recording method, and encrypts the content with an externally obtained secret key when the recording unit adopts the second recording method.

16. The recording apparatus according to claim 14,
wherein the recording method includes a first recording method and a second recording method compliant with the method for protecting a copyright of a content, and
the content obtainment unit reencrypts the content into an encrypted content corresponding to the second recording method and sends the reencrypted content to the recording unit when the obtained content is an encrypted content corresponding to the first recording method.

17. A content protection system comprising a server apparatus and a terminal apparatus connected via a transmission channel;
wherein the server apparatus includes:
a readout unit operable to read out an encrypted content and decryption information for decrypting the encrypted content from a recording medium on which the encrypted content and the decryption information are recorded; and
a sending unit operable to send the readout encrypted content and decryption information to the terminal apparatus via the transmission channel, and
the terminal apparatus includes:
a receiving unit operable to receive the encrypted content and the decryption information to be sent via the transmission channel; and
a decryption unit operable to decrypt the received encrypted content using the decryption information received,
wherein the sending unit sends the decryption information via a secure transmission channel after establishing the secure transmission channel between the server apparatus and the terminal apparatus.

18. The content protection system according to claim 17,
wherein the decryption information includes medium identification information for identifying the recording medium stored in a non-rewritable area of the recording medium.

19. The content protection system according to claim 17,
wherein the terminal apparatus further includes a reproduction unit operable to play back the content decrypted by the decryption unit as at least one of a sound or an image.

20. The content protection system according to claim 17,
wherein the terminal apparatus further includes a recording unit which records the content decrypted by the decryption unit onto a recording medium.

21. The content protection system according to claim 20,
wherein the recording unit encrypts the content decrypted by the decryption unit using an encryption method different from an encryption corresponding to the decryption and records the encrypted content onto the recording medium.

22. A terminal apparatus which is connected to a server apparatus via a transmission channel,
wherein the server apparatus includes:
a readout unit operable to read out an encrypted content and decryption information from a recording medium on which the encrypted content and the decryption information required for decrypting the encrypted content are recorded; and
a sending unit operable to send the readout encrypted content and the decryption information to the terminal apparatus via the transmission channel, and
the terminal apparatus includes:
a receiving unit operable to receive the encrypted content and the decryption information to be sent via the transmission channel; and
a decryption unit operable to decrypt the received encrypted content with the decryption information,
wherein the sending unit sends the decryption information via a secure transmission channel after establishing the secure transmission channel between the server apparatus and the terminal apparatus.

23. A recording method for recording a content which is a digital copyrighted work onto a recording medium, comprising:
a content obtainment step of obtaining a content provided externally;
a content type identification step of identifying a type of the obtained content;
a recording medium type identification step of identifying a type of the recording medium;
a recording method selection step of selecting at least one recording method out of a plurality of recording methods based on the type of the content identified in the content type identification step and the type of the recording medium identified in the recording medium type identification step; and
a recording step of recording the content onto the recording medium according to the selected recording method.

24. A recording method used for a content protection system comprising a server apparatus and a terminal apparatus connected via a transmission channel, the recording method comprising steps A executed on the server apparatus and steps B executed on the terminal apparatus,
wherein the steps A include:
a readout step of reading out an encrypted content and decryption information from a recording medium on which the encrypted content and the decryption information required for decrypting the encrypted content; and
a sending step of sending the readout encrypted content and the decryption information to the terminal apparatus via the transmission channel, and
the steps B include:
a receiving step of receiving the encrypted content and the decryption information to be sent via the transmission channel; and
a decryption step of decrypting the received encrypted content with the received decryption information,
wherein the sending step sends the decryption information via a secure transmission channel after establishing the secure transmission channel.

25. A recording medium on which a content that is a digital copyrighted work is recorded by a recording apparatus,
wherein the recording apparatus includes:
a content obtainment unit operable to obtain a content provided externally;
a content type identification unit operable to identify a type of the obtained content;
a recording medium type identification unit operable to identify a type of the recording medium;
a recording method selection unit operable to select at least one recording method out of a plurality of recording methods based on the type of the content identified by the content type identification unit and the type of the recording medium identified by the recording medium type identification unit; and
a recording unit operable to record the content on the recording medium according to the selected recording method.

26. A program for a recording method for recording a content which is a digital copyrighted work on a recording medium, comprising:
a content obtainment step of obtaining a content provided externally;
a content type identification step of identifying a type of the obtained content;
a recording medium type identification step of identifying a type of the recording medium;
a recording method selection step of selecting at least one recording method out of a plurality of recording methods based on the type of the content identified by the content type identification step and the type of the recording medium identified by the recording medium type identification step; and
a recording step of recording the content on the recording medium according to the selected recording method.
